(19) United States
(12) Patent Application Publication
(10) Pub. No.: US 2026/0186332 A1
(43) Pub. Date: Jul. 2, 2026

(54) DISPLAY APPARATUS HAVING A VIEWING ANGLE CONTROL UNIT, AND VEHICLE

(71) Applicant: LG Display Co., Ltd., Seoul (KR)

(72) Inventors: Su Hun LEE, Paju-si (KR); Jae Jung HAN, Paju-si (KR); Se Min LEE, Paju-si (KR)

(73) Assignee: LG Display Co., Ltd., Seoul (KR)

(21) Appl. No.: 19/418,625

(22) Filed: Dec. 12, 2025

(30) Foreign Application Priority Data
Dec. 26, 2024 (KR) 10-2024-0197238

(51) Int. Cl. G02F 1/13; B60K 35/22; F21V 8/00; G02F 1/1335

(52) U.S. Cl. CPC G02F 1/1323; B60K 35/22; G02B 6/005; G02F 1/133509; B60K 2360/23; B60K 2360/336

(57) ABSTRACT

A display apparatus can include a display panel on a back-light unit. The back-light unit can include an optical sheet disposed parallel to the display panel. A viewing angle control unit can be disposed between the optical sheet and the display panel. The viewing angle control unit can include light-blocking patterns extending in a first direction and optical lenses on the light-blocking pattern. The light-blocking patterns can be spaced in a second direction perpendicular to the first direction. Each of the optical lenses can include a region disposed between adjacent light-blocking patterns. Each of the light-blocking patterns can have a stacked structure of a reflective layer, a light trap layer and a thin metal layer. Thus, in the display apparatus, the quality of the image having a narrow viewing angle can be improved by the viewing angle control unit.

### CROSS-REFERENCE TO RELATED APPLICATIONS

This application claims priority to Korean Patent Application No. 10-2024-0197238, filed in the Republic of Korea on Dec. 26, 2024, which is hereby expressly incorporated by reference as if fully set forth herein.

### BACKGROUND OF THE INVENTION

### Field of the Invention

The present disclosure relates to a display apparatus in which a viewing angle control unit is disposed between an optical sheet of a back-light unit and the display panel.

### Discussion of the Related Art

Generally, a display apparatus provides an image to a user. For example, the display apparatus can include a display panel on an optical sheet of a back-light unit. The display panel can realize the image using light provided through the optical sheet. For example, the display panel can be a liquid crystal panel including a liquid crystal layer.

A viewing angle control unit can be disposed between the optical sheet of the back-light unit and the display panel. The viewing angle control unit can include light-blocking patterns extending parallel in a first direction. The viewing angle of the light provide to the display panel through the optical sheet can be reduced by the light-blocking patterns. For example, in the display apparatus, the image realized by the display panel may not be recognized by people located around the user in the second direction.

### SUMMARY OF THE INVENTION

Accordingly, the present disclosure is directed to a display apparatus that substantially obviates one or more problems due to limitations and disadvantages of the related art.

An object of the present disclosure is to provide a display apparatus capable of preventing or minimizing a decrease in the quality of the image due to the viewing angle control unit.

Another object of the present disclosure is to provide a display apparatus capable of preventing or minimizing a decrease in the luminance due to the light-blocking patterns.

Additional advantages, objects, and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

To achieve these objects and other advantages and in accordance with the purpose of the present disclosure, as embodied and broadly described herein, there is provided a display apparatus comprising a back-light unit. The back-light unit includes a lower light-guide plate. An upper viewing angle control unit is disposed on the lower light-guide plate. The viewing angle control unit includes upper light-blocking patterns and upper optical lenses, which are sequentially stacked. The upper light-blocking patterns are spaced in a first direction. Each of the upper optical lenses includes a region disposed between the upper light-blocking patterns. The upper light-blocking patterns extend in a second direction. The second direction is a direction perpendicular to the first direction. Each of the upper light-blocking patterns includes a reflective layer, a light trap layer and a thin metal layer. The light trap layer is disposed between the reflective layer and the thin metal layer. The thin metal layer is disposed close to the display panel. The thin metal layer has a smaller than the reflective layer and the light trap layer. A display panel is disposed on the upper optical lenses of the upper viewing angle control unit.

According to aspects of the present disclosure, a surface of each upper optical lens toward the display panel can have a convex shape.

According to aspects of the present disclosure, the light trap layer can include a metal oxide.

According to aspects of the present disclosure, the light trap layer can include a different metal from the thin metal layer.

According to aspects of the present disclosure, the reflective layer can include a same material as the thin metal layer.

According to aspects of the present disclosure, the thin metal layer can have a thickness of 12 nm to 18 nm.

According to aspects of the present disclosure, a thickness of the light trap layer can be 30 nm to 107 nm.

According to aspects of the present disclosure, the reflective layer can have a larger thickness than the light trap layer.

According to aspects of the present disclosure, a lower viewing angle control unit can be disposed between the lower light-guide plate and the upper viewing angle control unit. An upper light-guide plate can be disposed between the lower viewing angle control unit and the upper viewing angle control unit. The lower viewing angle control unit can include lower light-blocking patterns extending parallel in the first direction.

According to aspects of the present disclosure, lower optical lenses can be disposed between the lower light-blocking patterns and the upper light-guide plate. Each of the lower optical lenses can include a region disposed between the lower light-blocking patterns that are spaced in the second direction. Each of the lower light-blocking patterns can have a same stacked structure as each upper light-blocking pattern.

In another embodiment of the present disclosure, there is provided a display apparatus comprising a back-light unit. The back-light unit includes a first optical sheet. A first viewing angle control unit is disposed on the first optical sheet. The first viewing angle control unit includes first light-blocking patterns, a control substrate and optical lenses. The first light-blocking patterns are disposed on a first surface of the control substrate toward the first optical sheet. The first light-blocking patterns extend in a first direction. The first light-blocking patterns are spaced in a second direction. The second direction is a direction perpendicular to the first direction. The optical lenses are disposed on a second surface of the control substrate. The second surface of the control substrate is opposite to the first surface of the control substrate. Each of the optical lenses includes a region disposed between the first light-blocking patterns. Each of the first light-blocking patterns has a structure in which a thin metal layer, a light trap layer and a reflective layer are sequentially stacked on the first surface of the control substrate. The light trap layer has a larger thickness than the thin metal layer. The reflective layer has a larger thickness than the light trap layer. A display panel is disposed on the optical lenses of the first viewing angle control unit.

According to aspects of the present disclosure, the light trap layer can be made of a metal oxide including a same material as the thin metal layer.

According to aspects of the present disclosure, a second viewing angle control unit can be disposed between the first viewing angle control unit and the display panel. A light-guide plate can be disposed between the first viewing angle control unit and the second viewing angle control unit. A second optical sheet can be disposed between the light-guide plate and the second viewing angle control unit. Upper light-source devices are disposed side by side on a surface of the light-guide plate. The second viewing angle control unit can include second light-blocking patterns extending in the second direction. A structure of each second light-blocking pattern can be different from a structure of each first light-blocking pattern.

According to aspects of the present disclosure, each of the second light-blocking patterns can include a black dye.

According to aspects of the present disclosure, the back-light unit can include a light-source substrate and lower light-source devices. The lower light-source devices can be disposed side by side on a surface of a light-source substrate. The first optical sheet, the first viewing angle control unit and the display panel can be disposed parallel to the light-source substrate on the lower light-source devices.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a view schematically showing a display apparatus according to an embodiment of the present disclosure;

FIG. 2 is a view taken along lines I-I′ and II-II′ of FIG. 1 according to an example of the present disclosure;

FIG. 3 is a view showing a moving path of light in a wide viewing angle mode of the display apparatus according to the display apparatus according to an embodiment of the present disclosure;

FIG. 4 is a view showing a moving path of light in a narrow viewing angle mode of the display apparatus according to an embodiment of the present disclosure;

FIG. 5 is an enlarged view of K region in FIG. 4 according to an example of the present disclosure;

FIGS. 6 and 7 are views showing the luminance distribution of light passing through the viewing angle control unit according to the configuration of the viewing angle control unit; and

FIGS. 8 to 16 are views showing the display apparatus according to another embodiment of the present disclosure.

### DETAILED DESCRIPTION OF THE EMBODIMENTS

Hereinafter, details related to the above objects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be satisfactorily transferred to those skilled in the art, and thus the present disclosure can be embodied in other forms and is not limited to the embodiments described below.

In addition, the same or extremely similar elements can be designated by the same reference numerals throughout the specification and in the drawings, the lengths and thickness of layers and regions can be exaggerated for convenience. It will be understood that, when a first element is referred to as being “on” a second element, although the first element can be disposed on the second element so as to come into contact with the second element, a third element can be interposed between the first element and the second element.

Here, terms such as, for example, “first” and “second” can be used to distinguish any one element with another element. However, the first element and the second element can be arbitrary named according to the convenience of those skilled in the art without departing the technical sprit of the present disclosure.

The terms used in the specification of the present disclosure are merely used in order to describe particular embodiments, and are not intended to limit the scope of the present disclosure. For example, an element described in the singular form is intended to include a plurality of elements unless the context clearly indicates otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

Further, unless ‘directly’ is used, the terms “connected” and “coupled” can include that two components are “connected” or “coupled” through one or more other components located between the two components. In addition, the term “can” fully encompasses all the meanings and coverages of the term “may” and vice versa.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

### EMBODIMENTS

Various embodiments of the present disclosure will now be described referring to the drawings. All the components of each display apparatus/device according to all embodiments of the present disclosure are operatively coupled and configured.

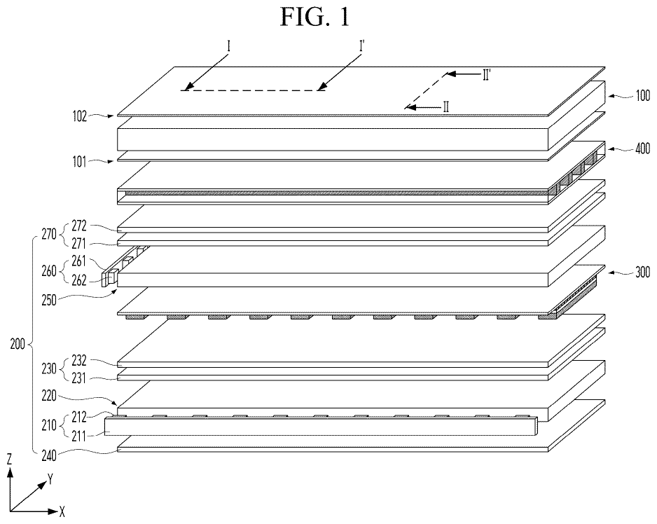

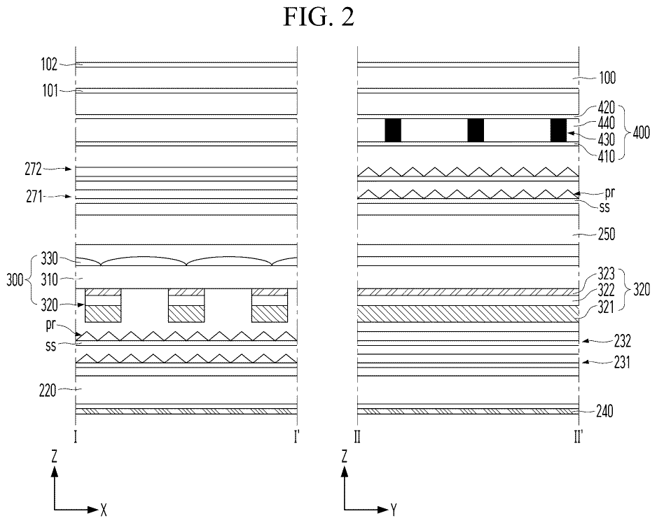

FIG. 1 is a view schematically showing a display apparatus according to an embodiment of the present disclosure. FIG. 2 is a view taken along lines I-I′ and II-II′ of FIG. 1 according to an example of the present disclosure.

Referring to FIGS. 1 and 2, the display apparatus according to the embodiment of the present disclosure can include a display panel 100. The display panel 100 can realize an image provided to a user. The display panel 100 can be disposed on a back-light unit 200. The display panel 100 can realize the image using light provided from the back-light unit 200. For example, the display panel 100 can be a liquid crystal panel including a liquid crystal layer.

The display panel 100 can be disposed between a first linear polarizer 101 and a second linear polarizer 102. At least one of the first linear polarizer 101 and the second linear polarizer 102 can be in direct contact with the display panel 100. For example, a lower surface of the display panel 100 toward the back-light unit 200 can be in direct contact with the first linear polarizer 101, and an upper surface of the display panel 100 opposite to the lower surface of the display panel 100 can be in direct contact with the second linear polarizer 102. A transmission axis of the second linear polarizer 102 can be perpendicular to a transmission axis of the first linear polarizer 101. Thus, in the display apparatus according to the embodiment of the present disclosure, the image realized by the display panel 100 can include various luminance and contrast levels.

The back-light unit 200 can include a lower light-source unit 210, a lower light-guide plate 220, a lower optical sheet 230, a reflective plate 240, an upper light-guide plate 250, an upper light-source unit 260 and an upper optical sheet 270.

The lower light-source unit 210 can provide to the lower light-guide plate 220, in a narrow viewing angle mode. For example, the lower light-source unit 210 can include lower light-source devices 212 mounted on a lower light-source substrate 211. The lower light-source substrate 211 can include various signal lines to control the lower light-source devices 212. For example, the lower light-source substrate 211 can be a printed circuit board (PCB) in which signal lines are formed. The lower light-source substrate 211 can be disposed on a side surface of the lower light-guide plate 220. For example, the lower light-source substrate 211 can extend along a side surface of the lower light-guide plate 220. The lower optical light-source devices 212 can be disposed side by side on a surface of the lower light-source substrate 211 toward the lower light-guide plate 220. Each of the lower light-source devices 212 can emit light travelling toward the lower light-guide plate 220. For example, each of the lower light-source devices 212 can include a light emitting diode (LED).

The lower light-guide plate 220 can be disposed between the lower optical sheet 230 and the reflective plate 240. For example, the lower optical sheet 230 can be disposed on an upper surface of the lower light-guide plate 220, and the reflective plate 240 can be disposed on a lower surface of the lower light-guide plate 220 opposite to the upper surface of the lower light-guide plate 220. The light provided from the lower light-source devices 212 can be provided to the entire area of the lower optical sheet 230 through the upper surface of the lower light-guide plate 220. The reflective plate 240 can include a material having a relatively high reflectance. Thus, in the display apparatus according to the embodiment of the present disclosure, the light emitted through the lower surface of the lower light-guide plate 220 can be reflected toward the lower optical sheet 230 by the reflective plate 240. Therefore, in the display apparatus according to the embodiment of the present disclosure, efficiency of the lower light-source unit 210 can be improved.

The light emitted through the upper surface of the lower light-guide plate 220 can have uniform characteristics as a whole by the lower optical sheet 230. For example, the lower optical sheet 230 can includes at least one lower prism sheet 231 and 232. Each of the lower prism sheets 231 and 232 can include first prisms pr disposed side by side on a surface of the first sheet substrate ss.

The first sheet substrate ss can include a transparent material. For example, the first sheet substrate s1 can include plastic. The first prisms pr can extend parallel in a direction. An extending direction of each prism pr can be perpendicular to an extending direction of the lower light-source substrate 211. For example, the lower light-source substrate 211 can be disposed on a side surface of the lower light-guide plate 220 extending a first direction X, and each of the first prisms pr can extend in a second direction Y perpendicular to the first direction X on an upper surface of the first sheet substrate ss opposite to the lower light-guide plate 220. The first prisms p1 can be disposed side by side in the first direction X. Thus, in the display apparatus according to the embodiment of the present disclosure, the light emitted through the upper surface of the lower light-guide plate 220 can be diffused in the first direction X by the first prisms pr. For example, deviation in luminance by the lower light-source devices 212 disposed side by side in the first direction X can be mitigated by the first prisms pr. Therefore, in the display apparatus according to the embodiment of the present disclosure, uniformity of the light passing through the lower optical sheet 230 can be improved.

The upper light-guide plate 250 can be disposed on the lower light-guide plate 220. The upper light-guide plate 250 can be disposed parallel to the lower light-guide plate 220 and the lower optical sheet 230. A lower surface of the upper light-guide plate 250 toward the lower light-guide plate 220 can overlap with the lower optical sheet 230. Thus, in the display apparatus according to the embodiment of the present disclosure, the light passing through the lower optical sheet 230 can be provided to the upper light-guide plate 250.

The upper light-source unit 260 can provide to the upper light-guide plate 250, in a wide viewing angle mode. For example, the upper light-source unit 260 can include upper light-source devices 262 mounted on an upper light-source substrate 261.

The upper light-source substrate 261 can include various signal lines to control the upper light-source devices 262. For example, the upper light-source substrate 261 can be a printed circuit board (PCB) in which signal lines are formed. The upper light-source substrate 261 can have a same stacked structure as the lower light-source substrate 211.

The upper light-source substrate 261 can be disposed on a side surface of the upper light-guide plate 250. For example, the upper light-source substrate 261 can extend along a side surface of the upper light-guide plate 250. A side surface of the upper light-guide plate 250 toward the upper light-source substrate 261 can extend in a different direction from the side surface of the lower light-guide plate 220 toward the lower light-source substrate 211. For example, the upper light-source substrate 261 can be disposed on a side surface of the upper light-guide plate 250 extending in the second direction Y.

The upper light-source devices 262 can be disposed on a surface of the upper light-source substrate 261 toward the upper light-guide plate 250. Each of the upper light-source devices 262 can emit toward the upper light-guide plate 250. For example, each of the upper light-source devices 262 can include a light emitting diode (LED). Each of the upper light-source devices 262 can have a same or similar structure as each lower light-source device 212, or may have a different structure from each lower light-source device 212.

The upper optical sheet 270 can be disposed on an upper surface of the upper light-guide plate 250 opposite to the lower surface of the upper light-guide plate 250. The light passing through the lower optical sheet 230 and the light provided by the upper light-source devices 262 can be provided to an entire area of the upper optical sheet 270 through the upper surface of the upper light-guide plate 250. The upper optical sheet 270 can be disposed parallel to the lower light-guide plate 220, the lower optical sheet 230 and the upper light-guide plate 250.

The light emitted through the upper surface of the upper light-guide plate 250 can have uniform characteristics as a whole by the upper optical sheet 270. For example, the upper optical sheet 270 can include at least one upper prism sheet 271 and 272. Each of the upper prism sheets 271 and 272 can have a same or similar structure as each of the lower prism sheet 231 and 232. For example, each of the upper prism sheets 271 and 272 can include second prisms pr disposed side by side on a surface of a second sheet substrate ss.

The second sheet substrate ss can include a transparent material. For example, the second sheet substrate ss can include plastic. The second sheet substrate ss can include a same material as the first sheet substrate ss.

The second prisms pr can extend parallel in a direction. An extending direction of each second prism pr can be perpendicular to an extending direction of the upper light-source substrate 261. For example, the second prisms pr can be disposed side by side in the second direction Y, and each of the second prisms pr can extend in the first direction X on the upper surface of the second sheet substrate ss opposite to the upper light-guide plate 250. Thus, in the display apparatus according to the embodiment of the present disclosure, the light provided to the upper light-guide plate 250 from the upper light-source devices 262 can be diffused in the second direction Y by the second prisms pr. Therefore, in the display apparatus according to the embodiment of the present disclosure, uniformity of the light passing through the upper optical sheet 270.

A first viewing angle control unit 300 can be disposed between the lower optical sheet 230 and the upper light-guide plate 250. The first viewing angle control unit 300 can limit a viewing angle of the light passing through the lower optical sheet 230. For example, the first viewing angle control unit 300 can include first light-blocking patterns 320 and optical lenses 330. The first light-blocking patterns 320 and the optical lenses 330 are supported by a control substrate 310.

The control substrate 310 can include a transparent material. The control substrate 310 can include an insulating material. For example, the control substrate 310 can include glass or plastic. The control substrate 310 can be disposed parallel to the lower optical sheet 230 and the upper light-guide plate 250. For example, a lower surface of the control substrate 310 toward the lower light-guide plate 220 can overlap with the lower optical sheet 230, and the upper light-guide plate 250 can overlap with an upper surface of the control substrate 310 toward the upper optical sheet 270.

The first light-blocking patterns 320 can be disposed side by side on the lower surface of the control substrate 310. Each of the first light-blocking patterns 320 can extend in the second direction Y. The first light-blocking patterns 320 adjacent in the first direction X can be spaced apart from each other. Each of the first light-blocking patterns 320 can include a thin metal layer 323, a light trap layer 322 and a reflective layer 321, which are sequentially stacked on the lower surface of the control substrate 310. For example, the thin metal layer 323 of each first light-blocking pattern 320 can be in direct contact with the lower surface of the control substrate 310.

The reflective layer 321 of each first light-blocking pattern 320 disposed close to the lower optical sheet 230 can include a material having a high reflectance. For example, the reflective layer 321 of each first light-blocking pattern 320 can include a metal, such as aluminum (Al), silver (Ag), copper (Cu), nickel (Ni), chromium (Cr), and tungsten (W). Thus, in the display apparatus according to the embodiment of the present disclosure, a viewing angle of the light passing through the lower optical sheet 230 in the first direction can be primarily reduced by the reflective layer 321 of each first light-blocking pattern 320. For example, in the display apparatus according to the embodiment of the present disclosure, the light provided to the user passing through the lower optical sheet 230 cannot be recognized by people located side by side with the user in the first direction by the reflective layer 321 of each first light-blocking pattern 320. Therefore, in the display apparatus according to the embodiment of the present disclosure, the image from by the light passing through the lower optical sheet 230 and the first viewing angel control unit 300 cannot be shared with people located side by side with the user in the first direction X.

The light trap layer 322 of each first light-blocking pattern 320 can be disposed between the reflective layer 321 and the thin metal layer 323 of the corresponding light-blocking pattern 320. The light trap layer 322 of each first light-blocking pattern 320 can include a material having a relative low transmittance. For example, the light trap layer 322 of each first light-blocking pattern 320 can include a metal oxide. The light trap layer 322 of each first light-blocking pattern 320 can include a different metal from the reflective layer 321 of the corresponding first light-blocking pattern 320. Thus, in the display apparatus according to the embodiment of the present disclosure, some of the light provided to the light trap layer 322 of each first light-blocking pattern 320 can be absorbed by the light trap layer 322 of the corresponding first light-blocking pattern 320. For example, the light trap layer 322 of each first light-blocking pattern 322 can include a light-absorbing material.

The thin metal layer 323 of each first light-blocking pattern 320 disposed close to the upper light-guide plate 250 can be a translucent layer in which a metal is formed thinly. The thin metal layer 323 of each first light-blocking pattern 320 can include a same metal as the reflective layer 321 of the corresponding first light-blocking pattern 320. For example, the thin metal layer 323 of each first light-blocking layer 320 can be a thin layer formed of at least one of aluminum (Al), silver (Ag), copper (Cu), nickel (Ni), chromium (Cr), and tungsten (W). The thin metal layer 323 of each first light-blocking pattern 320 can have a smaller thickness than the reflective layer 321 and the light trap layer 322 of the corresponding first light-blocking layer 320. Thus, in the display apparatus according to the embodiment of the present disclosure, some of the light travelling toward the lower light-guide plate 220 by passing through the control substrate 310 can be provided to the light trap layer 322 of each first light-blocking pattern 320 by passing through the thin metal layer 323 of the corresponding first light-blocking pattern 320. Therefore, in the display apparatus according to the embodiment of the present disclosure, some of the light travelling toward the lower light-guide plate 220 by passing through the control substrate 310 can be absorbed by the light trap layer 322 of each first light-blocking pattern 320.

The light passing through the thin metal layer 323 and the light trap layer 322 of each first light-blocking pattern 320 can be reflected by the reflective layer 321 of the corresponding first light-blocking pattern 320. At least some of the light reflected by the reflective layer 321 of each first light-blocking pattern 320 can be reflected at a boundary between the light trap layer 322 and the thin metal layer 323 of the corresponding first light-blocking pattern 320. Thus, in the display apparatus according to the embodiment of the present disclosure, at least some of the light passing through the thin metal layer 323 of each first light-blocking pattern 320 can be trapped between the reflective layer 321 and the thin metal layer 323 of the corresponding first light-blocking pattern 320. The light trapped between the reflective layer 321 and the thin metal layer 323 of each first light-blocking pattern 320 can be slowly absorbed into the light trap layer 322 of the corresponding first light-blocking pattern 320. Therefore, in the display apparatus according to the embodiment of the present disclosure, at least some of the light travelling toward the lower light-guide plate 220 passing through the control substrate 310 can be removed by the first light-blocking pattern 320. That is, in the display apparatus according to the embodiment of the present disclosure, the reflection of the light travelling toward the lower light-guide plate 220 by passing through the control substrate 310 by the reflective layer 321 of each first light-blocking pattern 320 can be reduced.

The optical lenses 330 can be disposed side by side on the upper surface of the control substrate 310. For example, the optical lenses 330 can be disposed side by side in the first direction X on the upper surface of the control substrate 310. The optical lenses 330 can be disposed to be in contact with each other or spaced apart from each other in the first direction X. Each of the optical lenses 330 can include a region disposed between adjacent first light-blocking patterns 320 in the first direction X. For example, the light passing between the first light-blocking patterns 320 can be focused by one of the optical lenses 330. Each of the optical lenses 330 can function as a convex lens. For example, a surface of each optical lens 330 toward the upper light-guide plate 250 can have a convex shape. The optical lenses 330 can extend in the second direction Y. Thus, in the display apparatus according to the embodiment of the present disclosure, the viewing angle of the light passing through the lower optical sheet 230 in the first direction X can be secondarily reduced by the optical lenses 330. Therefore, in the display apparatus according to the embodiment of the present disclosure, the viewing angle of the light passing through the lower optical sheet 230 in the first direction can be significantly reduced by the first light-blocking pattern 320 and the optical lenses 330. And, in the display apparatus according to the embodiment of the present disclosure, front luminance of the light passing between the first light-blocking patterns 320 can be increased by the optical lenses 330.

A lower surface of each optical lens 330 toward the lower light-guide plate 220 can have a larger size than each first light-blocking pattern 320. A lower surface of each optical lens 330 toward the lower light-guide plate 220 can have a larger size than a space between the first light-blocking patterns 320. For example, a length of the lower surface of each optical lens 330 in the first direction X can be a same as a pitch of the first light-blocking patterns 320 in the first direction X. Thus, in the display apparatus according to the embodiment of the present disclosure, a portion of each optical lens 330 between the first light-blocking patterns 320 can have a substantially constant shape. That is, in the display apparatus according to the embodiment of the present disclosure, the light passing between the first light-blocking patterns 320 can be focused in a substantially constant direction by the optical lenses 330. Therefore, in the display apparatus according to the embodiment of the present disclosure, a decrease in uniformity of the light due to the optical lenses 330 can be prevented or reduced.

A second viewing angle control unit 400 can be disposed between the upper optical sheet 270 of the back-light unit 200 and the display panel 100. The second viewing angle control unit 400 can limit a viewing angle of the light passing through the upper optical sheet 270. For example, the second viewing angle control unit 400 can include second light-blocking patterns 430 disposed between a first control substrate 410 and a second control substrate 420.

The first control substrate 410 and the second control substrate 420 can include a transparent material. For example, the first control substrate 410 and the second control substrate 420 can include plastic or glass. The second control substrate 420 can include a same material as the first control substrate 410.

The second light-blocking patterns 430 can be disposed side by side between the first control substrate 410 and the second control substrate 420. The second light-blocking patterns 430 can be disposed side by side in the second direction Y. Each of the second light-blocking patterns 430 can have a shape extending a third direction Z perpendicular to the first direction X and the second direction Y. For example, each of the second light-blocking patterns 430 can be in direct contact with at least one of an upper surface of the first control substrate 410 toward the second control substrate 420 and a lower surface of the second control substrate 420 toward the first control substrate 410. The second light-blocking patterns 430 can cross the first light-blocking pattern 320. For example, each of the second light-blocking patterns 430 can extend in the first direction. The second light-blocking patterns 430 adjacent in the second direction Y can be spaced apart from each other.

A structure of each second light-blocking pattern 430 can be different from a structure of each first light-blocking pattern 320. For example, each of the second light-blocking patterns 430 can be made of a light-blocking material. The light-blocking material can include a black dye, such as carbon black. Thus, in the display apparatus according to the embodiment of the present disclosure, a viewing angle of the light passing through the upper optical sheet 270 in the second direction Y can be reduced by the second light-blocking patterns 430. For example, in the display apparatus according to the embodiment of the present disclosure, the light emitted from the upper light-source devices 262 and passing through the upper optical sheet 270 can be provided to people or object located side by side with the user in the second direction Y by the second light-blocking pattern 430. And, in the display apparatus according to the embodiment of the present disclosure, the viewing angle of the light provided to the user by passing through the lower optical sheet 230 and the upper optical sheet 270 in the first direction X and the second direction Y can be limited.

The second light-blocking patterns 430 can be surrounded by a pattern insulating layer 440. The pattern insulating layer 440 can have a same thickness as each second light-blocking pattern 430. For example, a space between the first control substrate 410 and the second control substrate 420 can be completely filled by the second light-blocking patterns 430 and the pattern insulating layer 440. Thus, in the display apparatus according to the embodiment of the present disclosure, deformation of the second light-blocking patterns 430 due to external impact can be prevented or reduced. Therefore, in the display apparatus according to the embodiment of the present disclosure, distortion of the image by the light passing through the second viewing angle control unit 400 can be prevented.

The pattern insulating layer 440 can include an insulating material. The pattern insulating layer 440 can include a transparent material. A refractive index of the pattern insulating layer 440 can be substantially a same as a refractive index of the first control substrate 410 and a refractive index of the second control substrate 420. Therefore, in the display apparatus according to the embodiment of the present disclosure, loss of the light due to difference in a refractive index between the first control substrate 410 and the pattern insulating layer 440 and between the pattern insulating layer 440 and the second control substrate 420 can be minimized or reduced.

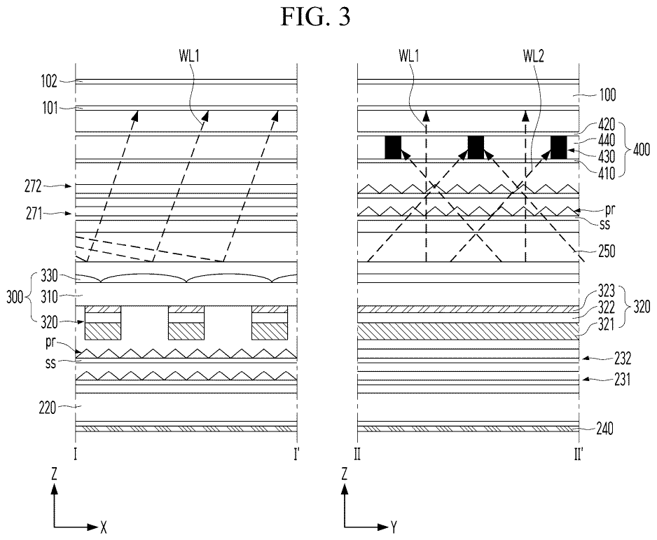

FIG. 3 is a view showing a moving path of light in the wide viewing angle mode of the display apparatus according to the display apparatus according to the embodiment of the present disclosure.

Referring to FIGS. 1 to 3, in the wide viewing angle mode of the display apparatus according to the embodiment of the present disclosure, the upper light-source devices 262 can emit toward the upper light-guide plate 250. Thus, in the wide viewing angle mode of the display apparatus according to the embodiment of the present disclosure, the light passing through the upper light-guide plate 250 and the upper optical sheet 270 can be provided to the display panel 100 through the second viewing angle control unit 400. That is, in the wide viewing angle mode of the display apparatus according to the embodiment of the present disclosure, the light provided to the display panel 100 does not pass through the first viewing angle control unit 300. For example, in the wide viewing angle mode of the display apparatus according to the embodiment of the present disclosure, the light emitted from the upper light-source devices 262 can include a first light WL1 passing between the second light-blocking patterns 430 of the second viewing angle control unit 400 and a second light WL2 blocked by the second light-blocking patterns 430 of the second viewing angle control unit 400. Therefore, in the wide viewing angle mode of the display apparatus according to the embodiment of the present disclosure, the viewing angle of the light provided to the display panel 100 in the first direction X cannot be limited.

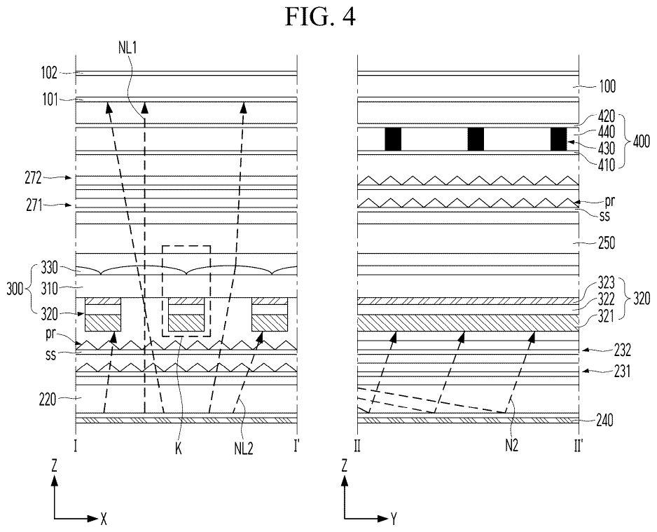

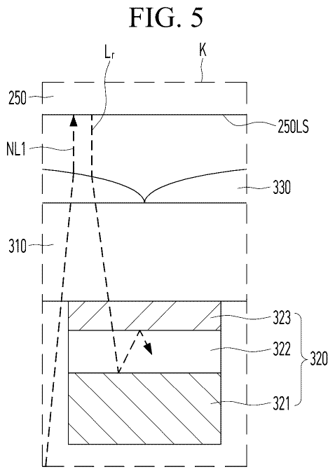

FIG. 4 is a view showing a moving path of light in the narrow viewing angle mode of the display apparatus according to the embodiment of the present disclosure. FIG. 5 is an enlarged view of K region in FIG. 4 according to an example of the present disclosure.

Referring to FIGS. 1, 2, 4 and 5, in the narrow viewing angle mode of the display apparatus according to the embodiment of the present disclosure, the lower light-source devices 212 can emit the light toward the lower light-guide plate 220, and the upper light-source devices 262 does not emit light. Thus, in the narrow viewing angle mode of the display apparatus according to the embodiment of the present disclosure, the light emitted through the upper surface of the lower light-guide plate 220 can be provided to the display panel 100 through the first viewing angle control unit 300 and the second viewing angle control unit 400. For example, in the narrow viewing angle mode of the display apparatus according to the embodiment of the present disclosure, the light emitted from the lower light-source devices 212 can include a third light NL1 passing between the first light-blocking patterns 320 of the first viewing angle control unit 300 and between the second light-blocking patterns 430 of the second viewing angle control unit 400 and a fourth light NL2 blocked by the reflective layer 321 of the first viewing angle control unit 300. Therefore, in the narrow viewing angle mode of the display apparatus according to the embodiment of the present disclosure, the viewing angle of the light provided to the display panel 100 in the first direction X can be limited by the first viewing angle control unit 300, and the viewing angle of the light provided to the display panel 100 in the second direction Y can be limited by the second viewing angle control unit 400. That is, in the narrow viewing angle mode of the display apparatus according to the embodiment of the present disclosure, both the viewing angle of the light provided to the display panel 100 in the first direction X and the viewing angle of the light provided to the display panel 100 in the second direction Y can be limited.

In the narrow viewing angle mode of the display apparatus according to the embodiment of the present disclosure, some of the light passing through the first viewing angle control unit 300 can be reflected at the lower surface 250LS of the upper light-guide plate 250. The light Lr reflected by the lower surface 250LS of the upper light-guide plate 250 can be provided to the light trap layer 322 of one of the first light-blocking patterns 320 (as an example, the first light-blocking pattern 320 adjacent to the space between first light-blocking patterns 320 through which the light emitted from the lower light-source devices 212 passes, without being limited thereto) by passing through the thin metal layer 323 of the corresponding light-blocking pattern 320. The light trap layer 322 of each first light-blocking pattern 320 can absorb at least some of the provided light. At least some of the light provided to the light trap layer 322 of each first light-blocking pattern 320 can be trapped between the reflective layer 321 and the thin metal layer 323 of the corresponding first light-blocking pattern 320. Thus, in the narrow viewing angle mode of the display apparatus according to the embodiment of the present disclosure, reflection of the light Lr reflected at the lower surface 250LS of the upper light-guide plate 250 by the reflective layer 321 of each first light-blocking pattern 320 can be significantly reduced. For example, in the narrow viewing angle mode of the display apparatus according to the embodiment of the present disclosure, most of the light Lr reflected at the lower surface 250LS of the upper light-guide plate 250 can be removed by the first light-blocking patterns 320. Therefore, in the narrow viewing angle mode of the display apparatus according to the embodiment of the present disclosure, the viewing angle of the light provided to the display panel 100 in the first direction X cannot be increased by the light Lr reflected at the lower surface 250LS of the upper light-guide plate 250.

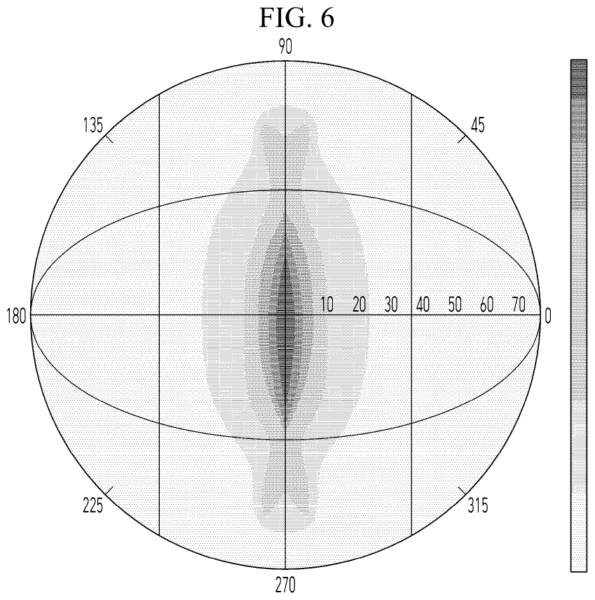

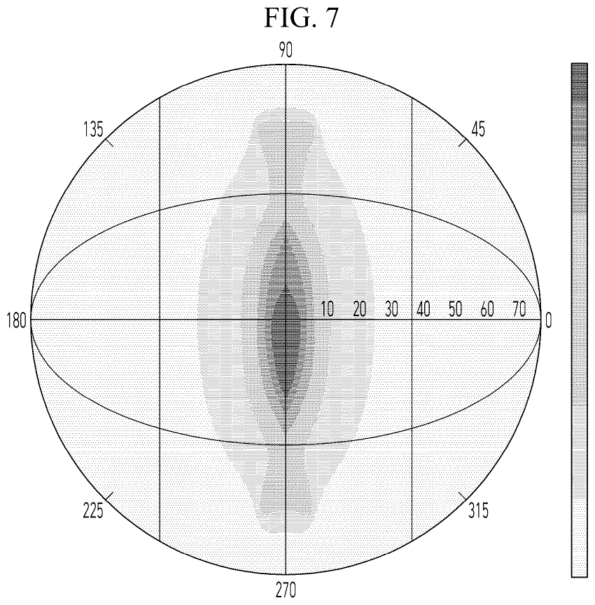

FIG. 6 is a view showing the luminance distribution of light passing through the viewing angle control unit including the light-blocking patterns made of light-blocking material. FIG. 7 is a view showing the luminance distribution of light passing through the viewing angle control unit in which each of the light-blocking patterns has a stacked structure of the reflective layer, the light trap layer and the thin metal layer.

Referring to FIGS. 6 and 7, the front luminance of the light passing through the viewing angle control unit in which each of the light-blocking patterns has a stacked structure of the reflective layer, the light trap layer and the thin metal layer can be higher than the front luminance of the light passing through the viewing angle control unit including the light-blocking patterns made of light-blocking material. That is, in the display apparatus according to the embodiment of the present disclosure including the first viewing angle control unit 300, the front luminance of the light provided to the display panel 100 in the narrow viewing angle mode can be improved, compared to the comparative display apparatus in which the first viewing angle control unit 300 is replaced with a viewing angle control unit including the light-blocking patterns made of a light-blocking material. Therefore, in the display apparatus according to the embodiment of the present disclosure, the quality of the image provided to the user in the narrow viewing angle mode can be improved.

Accordingly, the display apparatus according to the embodiment of the present disclosure can comprise the first viewing angle control unit 300 between the lower optical sheet 230 and the upper light-guide plate 250 of the back-light unit 200, and the second viewing angle control unit 400 between the upper optical sheet 270 of the back-light unit 200 and the display panel 100, wherein the first viewing angle control unit 300 can have a stacked structure of the first light-blocking patterns 320 and the optical lenses 330, wherein each of the optical lenses 330 can include a region disposed between the first light-blocking patterns 320 spaced in the first direction X, wherein each of the first light-blocking patterns 320 extending in the second direction Y can have a stacked structure of the reflective layer 321, the light trap layer 322 and the thin metal layer 323, and wherein the thin metal layer 323 disposed close to the display panel 100 can have a smaller thickness than the reflective layer 321 and the light trap layer 322. Thus, in the display apparatus according to the embodiment of the present disclosure, the viewing angle of the light provided to the display panel 100 through the lower optical sheet 230 in the first direction X can be limited by the first light-blocking patterns 320, and the front luminance of the light provided to the display panel 100 through the lower optical sheet 230 can be improved by the optical lenses 330. Therefore, in the display apparatus according to the embodiment of the present disclosure, the image realized by the display panel 100 in the wide viewing angel mode can be shared with the user and people located side by side with the user in the first direction X, the image realized by the display panel 100 in the narrow viewing angle mode cannot be recognized by people located side by side with the user in the first direction X, and the quality of the image provided to the user by the display panel 100 in the narrow viewing angle mode can be improved.

TABLE 1 shows a reflectance ratio of the first light-blocking pattern 320 according to a thickness of the light trap layer 322. TABLE 2 shows a reflectance ratio of the first light-blocking pattern 320 according to a thickness of the thin metal layer 323. Here, TABLES 1 and 2 are values measured in a structure in which the light trap layer 322 made of copper oxide (Cu) is disposed between the reflective layer 321 and the thin metal layer 323, which are formed of a nickel-chromium (NiCr) alloy, and the reflective layer 321 has a greater thickness than the light trap layer 322.

TABLE 1

| | Thickness of light trap layer (nm) | | | | | | | |
|---|---|---|---|---|---|---|---|---|
| | X | 17 | 30 | 43 | 87 | 107 | 152 | 200 |
| Reflectance | 52.00 | 13.67 | 7.44 | 7.66 | 7.59 | 7.56 | 10.10 | 12.33 |
| ratio (%) | | | | | | | | |

TABLE 2

| | Thickness of thin metal layer (nm) | | | | | |
|---|---|---|---|---|---|---|
| | X | 12 | 18 | 22 | 27 | 31 |
| Reflectance | 14.25 | 7.29 | 7.44 | 9.84 | 12.39 | 15.17 |
| ratio (%) | | | | | | |

Referring to TABLE 1, if the light trap layer 322 has a thickness of 17 nm to 107 nm, the reflectance of the first light-blocking pattern 320 can be minimized or reduced. Referring to TABLE 2, if a thickness of the thin metal layer 323 is 12 nm to 18 nm, the reflectance of the first light-blocking pattern 320 can be minimized or reduced. That is, in the display apparatus according to the embodiment of the present disclosure, the light trap layer 322 of each first light-blocking pattern 320 can have a thickness of 17 nm to 107 nm, the thin metal layer 323 of each first light-blocking pattern 320 can have a thickness of 12 nm to 18 nm, and the reflective layer 321 of each first light-blocking pattern 320 can have a larger thickness than the light trap layer 322 of the corresponding first light-blocking pattern 320. Thus, in the display apparatus according to the embodiment of the present disclosure, an increase of the viewing angle in the first direction X by the light Lr reflected by the lower surface 250LS of the upper light-guide plate 250 in the narrow viewing angle mode can be significantly reduced. Therefore, in the display apparatus according to the embodiment of the present disclosure, the quality of the image provided to the user in the narrow viewing angle mode can be greatly improved.

The display apparatus according to the embodiment of the present disclosure is described that the light trap layer 322 of each first light-blocking pattern 320 includes a different material from the reflective layer 321 and the thin metal layer 323 of the corresponding first light-blocking pattern 320. However, in the display apparatus according to another embodiment of the present disclosure, the light trap layer 322 of each first light-blocking pattern 320 can be made of a metal oxide including a same material as the reflective layer 321 and the thin metal layer 323 of the corresponding first light-blocking pattern 320. For example, in the display apparatus according to another embodiment of the present disclosure, a process of forming the first light-blocking patterns 320 can include a step of forming a metal layer, a step of forming a metal oxide layer by oxidizing a surface of the metal layer, a step of forming the thin film layer including a same material as the metal layer on the metal oxide layer, a step of forming the thin metal layer 323 of each first light-blocking pattern 320 by patterning the thin film layer, a step of forming the light trap layer 322 of each first light-blocking pattern 320 by pattering the metal oxide layer, and a step of forming the reflective layer 321 of each first light-blocking pattern 320 by pattering the metal layer. Thus, in the display apparatus according to another embodiment of the present disclosure, a process of forming the first light-blocking patterns 320 can be simplified.

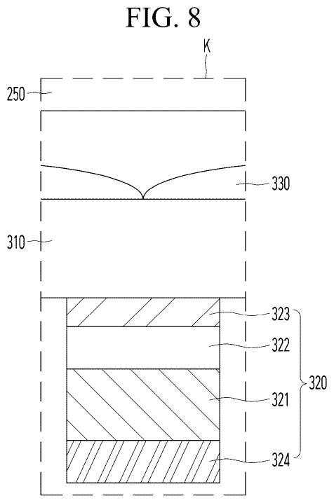

The display apparatus according to the embodiment of the present disclosure is described as each of the first light-blocking patterns 320 has a triple-layer structure. However, in the display apparatus according to another embodiment of the present disclosure, each of the first light-blocking patterns 320 can have various stacked structures. For example, in the display apparatus according to another embodiment of the present disclosure, each of the first light-blocking patterns 320 can include a blocking layer 324 on a lower surface of the reflective layer 321 toward the lower light-guide plate, as shown in FIG. 8. The blocking layer 324 can prevent reflection of the light at the lower surface of the reflective layer 321. For example, the blocking layer 324 can include an absorbing material. The blocking layer 324 can include an organic material or an inorganic material. For example, the blocking layer 324 can include a metal oxide. Thus, in the display apparatus according to another embodiment of the present disclosure, defects due to the light reflected at the lower surface of the reflective layer 321 can be reduced.

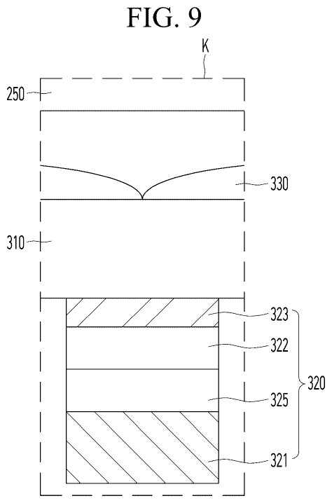

The display apparatus according to the embodiment of the present disclosure is described that the light trap layer 322 of each first light-blocking pattern 320 is in direct contact with the reflective layer 321 and the thin metal layer 323 of the corresponding first light-blocking pattern 320. However, in the display apparatus according to another embodiment of the present disclosure, the light trap layer 322 of each first light-blocking pattern 320 can be spaced apart from the reflective layer 321 and/or the thin metal layer 323 of the corresponding first light-blocking pattern 320. For example, in the display apparatus according to another embodiment of the present disclosure, each of the first light-blocking patterns 320 can include an absorbing layer 325 disposed between the reflective layer 321 and the light trap layer 322, as shown in FIG. 9. The absorbing layer 325 can have a lower transmittance than the light trap layer 322. For example, the absorbing layer 325 can include an absorbing material having a higher efficiency than the light trap layer 322. Thus, in the display apparatus according to another embodiment of the present disclosure, the reflectance of the light provided to the light trap layer 322 of each first light-blocking pattern 320 through the thin metal layer 323 of the corresponding light-blocking pattern 320 can be effectively prevented or reduced. Therefore, in the display apparatus according to another embodiment of the present disclosure, the quality of the image provided to the user in the narrow viewing angle mode can be effectively improved.

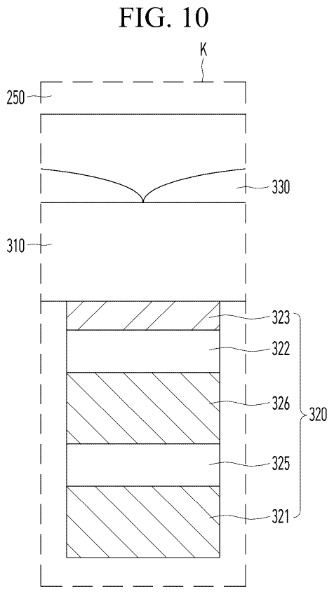

As shown in FIG. 10, in the display apparatus according to another embodiment of the present disclosure, each of the first light-blocking patterns 320 can include a transflective layer 326 disposed between the absorbing layer 325 and the light trap layer 322. The transflective layer 326 can include a metal. For example, the transflective layer 326 can include a same material as the reflective layer 321 and the thin metal layer 323. The transflective layer 326 can have a larger thickness than the light trap layer 322 and the thin metal layer 323. Some of the light provided to the light trap layer 322 through the thin metal layer 323 can pass through the transflective layer 326. The transflective layer 326 can reflect some of the light provided to the light trap layer 322 through the thin metal layer 323. Thus, in the display apparatus according to another embodiment of the present disclosure, the light provided to the light trap layer 322 through the thin metal layer 323 can be trapped between the transflective layer 326 and the thin metal layer 323 or be provided to the absorbing layer 325 by passing through the transflective layer 326. And, in the display apparatus according to another embodiment of the present disclosure, at least some of the light provided to the absorbing layer 325 can be trapped between the reflective layer 321 and the transflective layer 326. Therefore, in the display apparatus according to another embodiment of the present disclosure, the light reflected at the lower surface of the upper light-guide plate 250 can be effectively removed by the first light-blocking patterns 320. That is, in the display apparatus according to another embodiment of the present disclosure, the quality of the image provided to the user can be greatly improved.

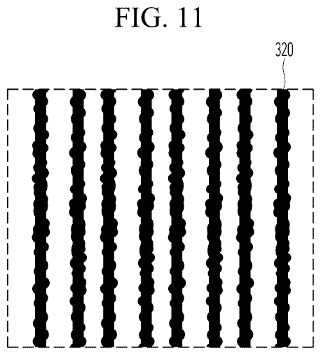

In the display apparatus according to another embodiment of the present disclosure, a side surface of each first light pattern 320 can have various shapes. For example, in the display apparatus according to another embodiment of the present disclosure, a side surface of the first light-blocking pattern 320 can have an uneven shape, as shown in FIG. 11. A side surface shape of each first light-blocking pattern 320 can be different from a side surface shape of adjacent first light-blocking pattern 320. Thus, in the display apparatus according to another embodiment of the present disclosure, a moire phenomenon due to repeated arrangement of the first light-blocking patterns 320 can be prevented or reduced. The side surface of the first light-blocking pattern 320 can have an uneven shape in the second direction Y. For example, the side surface of the first light-blocking pattern 320 can have an even shape in the second direction Y. Edges of each layer of the first light-blocking pattern 320 can be aligned with each other in the third direction Z.

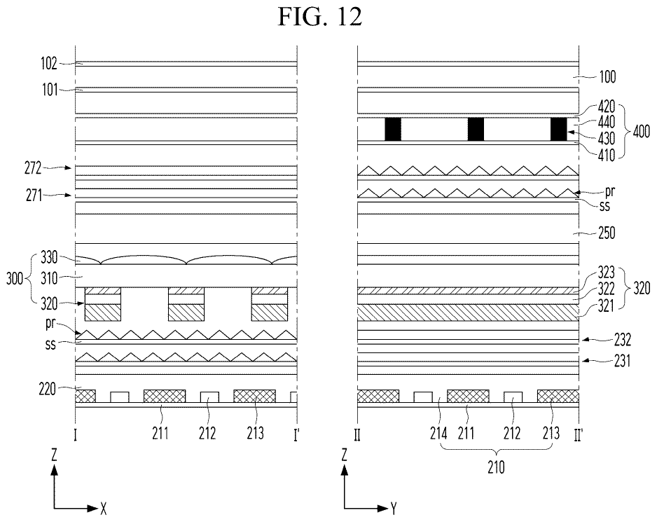

The display apparatus according to the embodiment of the present disclosure is described as the lower optical sheet 230 is disposed between the lower light-guide plate 220 and the first viewing angle control unit 300. However, in the display apparatus according to another embodiment of the present disclosure, the light generated by the lower light-source unit 210 can be directly provided to the lower optical sheet 230. For example, in the display apparatus according to another embodiment of the present disclosure, the lower light-source substrate 211 of the lower light-source unit 210 can be disposed parallel to the lower optical sheet 230, and the lower light-guide plate and the reflective plate can be omitted, as shown in FIG. 12. Thus, in the display apparatus according to another embodiment of the present disclosure, each of the lower light-source devices 212 can emit toward the lower optical sheet 230. That is, in the display apparatus according to another embodiment of the present disclosure, the back-light unit 200 can be a direct-type back-light unit. Therefore, in the display apparatus according to another embodiment of the present disclosure, the lower light-guide plate and the reflective plate can be omitted.

In the display apparatus according to another embodiment of the preset, the lower optical sheet 230 can include a diffusion sheet. Thus, in the display apparatus according to the embodiment of the present disclosure, the light emitted from the lower light-source unit 210 can be uniformly provided to the entire area of the display panel 100. And, in the display apparatus according to the embodiment of the present disclosure, the luminance of the light passing through the lower optical sheet 230 can be improved.

Reflective patterns 213 can be disposed between the lower light-source devices 212. The light reflected by the reflective layer 321 of each first light-blocking pattern 320 can be reflected toward the upper light-guide plate 250 by one of the reflective patterns 213. Thus, in the display apparatus according to another embodiment of the present disclosure, the quality of the image provided to the user in the narrow viewing angle mode can be improved.

The lower light-source devices 212 and the reflective patterns 213 can be covered by a light-source planarization layer 214. The light-source planarization layer 214 can include a transparent material. The light-source planarization layer 214 can include an adhesive material. For example, the light-source planarization layer 214 can be directly attached to a surface of the lower light-source substrate 211 between the lower light-source devices 212 and the reflective patterns 213. Thus, in the display apparatus according to another embodiment of the present disclosure, the lower light-source devices 212 and the reflective patterns 213 can be fixed on the lower light-source substrate 211 by the light-source planarization layer 214. And, in the display apparatus according to another embodiment of the present disclosure, damage of the lower light-source devices 212 and the reflective patterns 213 due to the external impact can be prevented. Therefore, in the display apparatus according to another embodiment of the present disclosure, defects due to movement and/or deformation of the lower light-source devices 212 and the reflective patterns 213 can be prevented or reduced.

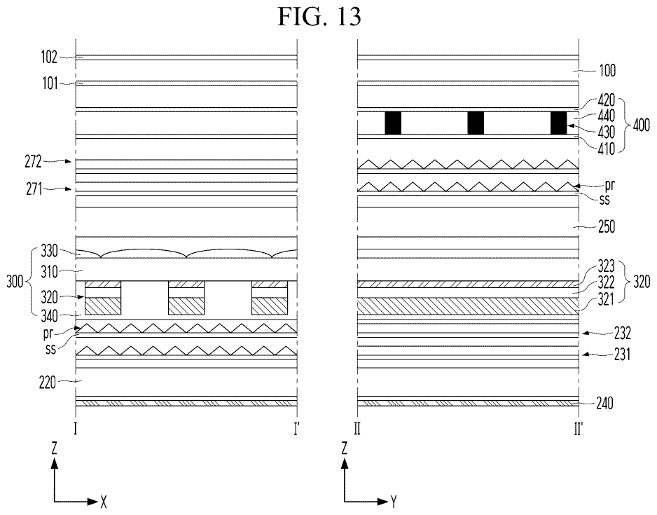

As shown in FIG. 13, in the display apparatus according to another embodiment of the present disclosure, the first viewing angle control unit 300 can include a pattern planarization layer 340 covering the first light-blocking patterns 320. The pattern planarization layer 340 can include a transparent material. The pattern planarization layer 340 can include an adhesive material. For example, the pattern planarization layer 340 can be attached to the lower surface of the control substrate 310 between the first light-blocking patterns 320. Thus, in the display apparatus according to another embodiment of the present disclosure, the first light-blocking patterns 320 can be fixed on the lower surface of the control substrate 310 by the pattern planarization layer 340. And, in the display apparatus according to another embodiment of the present disclosure, damage of the lower optical sheet 231 and 232 due to the first light-blocking patterns 320 can be prevented or reduced. Therefore, in the display apparatus according to another embodiment of the present disclosure, the quality of the image provided to the user in the narrow viewing angle mode can be improved.

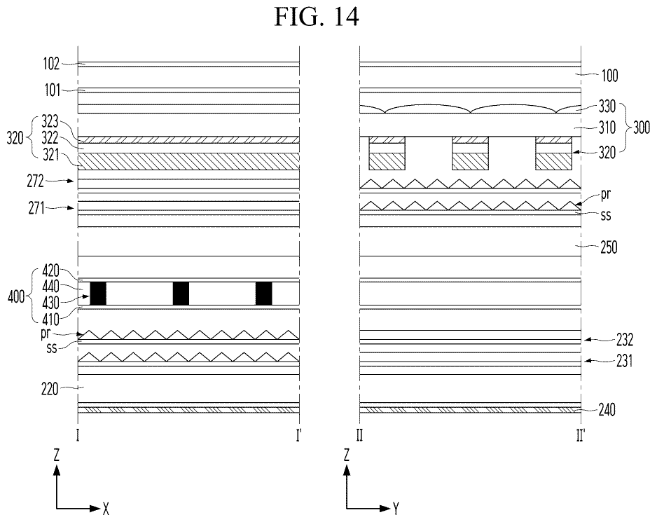

The display apparatus according to the embodiment of the present disclosure is described that the first viewing angel control unit 300 including the first light-blocking patterns 320 and the optical lenses 330 is disposed between the lower optical sheet 231 and 232 and the upper light-guide plate 250, and the second viewing angle control unit 400 including the second light-blocking patterns 430 surrounded by the pattern insulating layer 440 is disposed between the upper optical sheet 271 and 272 and the display pane 100. However, in the display apparatus according to another embodiment of the present disclosure, the first viewing angle control unit 300 and the second viewing angle control unit 400 can be arranged in various ways. For example, in the display apparatus according to another embodiment of the present disclosure, the second viewing angle control unit 400 can be disposed between the lower optical sheet 231 and 232 and the upper light-guide plate 250, and the first viewing angle control unit 300 can be disposed between the upper optical sheet 271 and 272 and the display panel 100, as shown in FIG. 14. Thus, in the display apparatus according to another embodiment of the present disclosure, at least some of the light reflected at a lower surface of the display panel 100 toward the upper light-guide plate 250 can be trapped between the reflective layer 321 and the thin metal layer 323 of each first light-blocking pattern 320, in the wide viewing angle mode. And, in the display apparatus according to another embodiment of the present disclosure, the reflection of the external light passing through the display panel 100 can be blocked by the first light-blocking patterns 320. Therefore, in the display apparatus according to another embodiment of the present disclosure, the quality of the image provided to the user in the wide viewing angle mode can be improved.

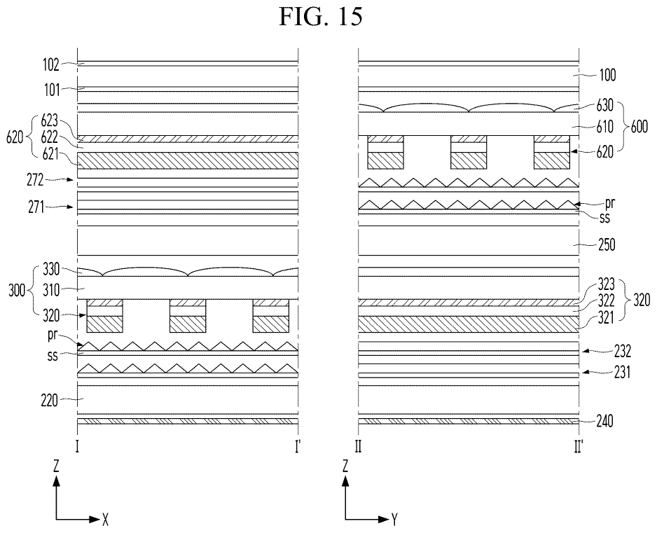

The display apparatus according to the embodiment of the present disclosure is described that the second viewing angle control unit 400 includes the second light-blocking patterns 430 surrounded by the pattern insulating layer 440. However, in the display apparatus according to another embodiment of the present disclosure, the second viewing angle control unit 400 can have various structures. For example, in the display apparatus according to another embodiment of the present disclosure, the second viewing angle control unit 600 disposed between the upper optical sheet 271 and 272 and the display panel 100 can include upper light-blocking patterns 620 and upper optical lenses 630, which are supported by the upper control substrate 610, as shown in FIG. 15.

The upper light-blocking patterns 620 and the upper optical lenses 630 can extend in the first direction X. The upper light-blocking patterns 620 can be spaced in the second direction Y. Each of the upper optical lenses 630 includes a region disposed between adjacent upper light-blocking patterns 620 in the second direction Y. A surface of each upper optical lens 630 toward the display panel 100 can have a convex shape. For example, each of the upper optical lenses 630 can function as a convex lens. A structure of each upper light-blocking pattern 620 can have a same structure as a structure of each first light-blocking pattern 320. For example, each of the upper light-blocking patterns 620 can have a stacked structure of an upper reflective layer 621, an upper light trap layer 622 and an upper thin metal layer 623. Thus, in the display apparatus according to another embodiment of the present disclosure, the quality of the image provided to the user in the narrow viewing angle mode and the quality of the image provided to the user in the wide viewing angle mode can be improved.

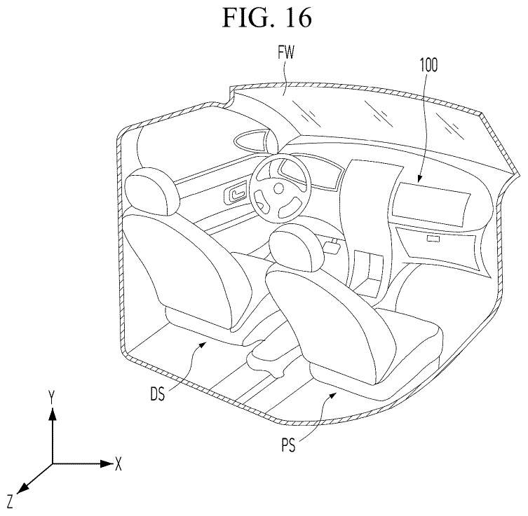

In the display apparatus according to another embodiment of the present disclosure, the display panel 100 can be installed in various places in which the image of the wide viewing angle mode and the image of the narrow viewing angle mode are selectively realized. For example, in the display apparatus according to another embodiment of the present disclosure, the display panel 100 can be installed inside a car, as shown in FIG. 16. The image realized by the display panel 100 can be provided to a driver sitting in a driver seat DS and/or a passenger sitting in a passenger seat PS. For example, the first direction X can be a direction between the driver seat DS and the passenger seat PS.

The display panel 100 can be disposed in front of the passenger seat PS. If the car moves, the display panel 100 can realize an image of the narrow viewing angle mode. Thus, in the display apparatus according to another embodiment of the present disclosure, if the car moves, the image realized by the display panel 100 cannot be recognized by the driver sitting in the driver seat DS. And, in the narrow viewing angle mode of the display apparatus according to another embodiment of the present disclosure, the image realized by the display panel 100 cannot be reflected by a front wind-shield FW disposed side by side with the display panel 100 in the second direction Y. That is, in the display apparatus according to another embodiment of the present disclosure, gaze dispersion of the driver sitting in the driver seat DS while driving the car can be prevented or reduced. Therefore, in the display apparatus according to another embodiment of the present disclosure, the accidents due to gaze dispersion of the driver can be prevented or reduced.

As a result, the display apparatus according to the embodiments of the present disclosure can comprise the display panel on the back-light unit and the viewing angle control unit on a path of the light provided to the display panel from the back-light unit, wherein the viewing angle control unit can have a stacked structure of the light-blocking patterns and the optical lenses, wherein each of the light-blocking patterns extending in the first direction can have a stacked structure of the reflective layer, the light trap layer and the thin metal layer, wherein each of the optical lenses on the thin metal layer of each light-blocking pattern can include a region disposed between the light-blocking patterns spaced in the second direction perpendicular to the first direction, and wherein the thin metal layer can have a smaller thickness than the reflective layer and the light trap layer. Thus, in the display apparatus according to the embodiments of the present disclosure, the light passing between the light-blocking patterns can be focused by one of the optical lenses. As such, in the display apparatus according to the embodiments of the present disclosure, the quality of the image realized by the display panel can be improved. Further, in the display apparatus according to the embodiments of the present disclosure, low-power operation can be possible, and power consumption can be reduced.

Although the embodiments of the present disclosure have been described in more detail with reference to the accompanying drawings, the present disclosure is not necessarily limited to these embodiments and can be modified and implemented in various manners without departing from the technical spirit of the present disclosure. Therefore, the embodiments disclosed herein are not intended to limit the technical spirit of the present disclosure, but to explain, and the scope of the technical spirit of the present disclosure is not limited by these embodiments. Therefore, the embodiments described above should be construed in all aspects as illustrative and not restrictive.

What is claimed is:

1. A display apparatus, comprising:
a back-light unit including a first lower light-guide plate;
a first viewing angle control unit including first light-blocking patterns, which are disposed on the first light-guide plate, are spaced apart in a first direction, and extends in a second direction perpendicular to the first direction; and
a display panel on the first viewing angle control unit,
wherein each of the first light-blocking patterns includes a reflective layer, a thin metal layer disposed on the reflective layer, and a light trap layer disposed between the reflective layer and the thin metal layer, and
wherein the thin metal layer disposed close to the display panel has a smaller thickness than the reflective layer and the light trap layer.

2. The display apparatus according to claim 1, wherein the first viewing angle control unit further includes first optical lenses, which are positioned on the first light-blocking patterns,
wherein each of the first optical lenses includes a region disposed between the first light-blocking patterns that are spaced apart in the first direction.

3. The display apparatus according to claim 2, wherein a lower surface of each of the first optical lens toward the first light-guide plate has a larger size than each of the first light-blocking pattern and has a larger size than a space between the first light-blocking patterns in the first direction.

4. The display apparatus according to claim 2, wherein a length of a lower surface of each of the first optical lens in the first direction is the same as a pitch of the first light-blocking patterns in the first direction.

5. The display apparatus according to claim 2, wherein a portion of each of the first optical lens between the first light-blocking patterns has a constant shape.

6. The display apparatus according to claim 1, wherein the light trap layer includes a light-absorbing material, and the thin metal layer is a translucent layer.

7. The display apparatus according to claim 1, wherein the light trap layer includes metal oxide, and
wherein the light trap layer includes a different metal from the thin metal layer.

8. The display apparatus according to claim 7, wherein the light trap layer includes an oxide of a metal material included in the thin metal layer.

9. The display apparatus according to claim 1, wherein the reflective layer includes a same material as the thin metal layer.

10. The display apparatus according to claim 1, wherein the reflective layer has a larger thickness than the light trap layer.

11. The display apparatus according to claim 1, further comprising a second viewing angle control unit above or below the first viewing angle control unit,
wherein the back-light unit further includes a second light-guide plate disposed below the second viewing angle control unit, and
wherein the second viewing angle control unit includes second light-blocking patterns extending parallel in the first direction.

12. The display apparatus according to claim 11, wherein the second viewing angle control unit includes second optical lenses disposed on the second light-blocking patterns,
wherein each of the second optical lenses includes a region disposed between the second light-blocking patterns that are spaced apart in the second direction, and
wherein each of the second light-blocking patterns has a same stacked structure as each of the first light-blocking patterns.

13. The display apparatus according to claim 1, wherein the light trap layer of each of the first light-blocking pattern is in direct contact with the reflective layer and the thin metal layer, or is spaced apart from at least one of the reflective layer and the thin metal layer.

14. The display apparatus according to claim 1, wherein side surfaces of the first light-blocking pattern have an uneven shape in the second direction.

15. A display apparatus, comprising:
a back-light unit including a first optical sheet;
a first viewing angle control unit including first light-blocking patterns, a control substrate and optical lenses, which are sequentially stacked on the first optical sheet; and
a display panel on the optical lenses of the first viewing angle control unit,
wherein the first light-blocking patterns disposed on a first surface of the control substrate toward the first optical sheet extend parallel in a first direction,
wherein each of the optical lenses that are disposed on a second surface of the control substrate toward the display panel includes a region disposed between the first light-blocking patterns that are spaced apart in a second direction perpendicular to the first direction, and
wherein each of the first light-blocking patterns has a structure in which a thin metal layer, a light trap layer having a larger thickness than the thin metal layer, and a reflective layer having a larger thickness than the light trap layer are sequentially stacked on the first surface of the control substrate.

16. The display apparatus according to claim 15, wherein the light trap layer is made of an oxide of metal material included in the thin metal layer.

17. The display apparatus according to claim 15, further comprising a second viewing angle control unit between the first viewing angle control unit and the display panel,
wherein the back-light unit includes:
a light-guide plate between the first viewing angle control unit and the second viewing angle control unit,
a second optical sheet between the light-guide plate and the second viewing angle control unit, and
upper light-source devices disposed side by side on a side surface of the light-guide plate,
wherein the second viewing angle control unit includes second light-blocking patterns extending in the second direction, and
wherein a structure of each second light-blocking pattern is different from a structure of each first light-blocking pattern.

18. The display apparatus according to claim 15, wherein the back-light unit includes lower light-source devices disposed side by side on an upper surface of a light-source substrate, and
wherein the first optical sheet, the first viewing angle control unit and the display panel, which are stacked on the lower light-source devices, are disposed parallel to the light-source substrate.

19. A vehicle, comprising the display apparatus according to claim 1.

20. The vehicle according to claim 19, wherein the display apparatus is disposed in front of a passenger seat,
the first direction is a direction between a driver seat and the passenger seat, and
a front wind-shield is disposed side by side with the display apparatus in the second direction.
